(19) United States
(12) Patent Application Publication
(10) Pub. No.: US 2016/0277075 A1
(43) Pub. Date: Sep. 22, 2016

(54) FORMATION OF COOPERATING SETS IN SMALL CELL DEPLOYMENT

(71) Applicant: NOKIA TECHNOLOGIES OY, Espoo (FI)

(72) Inventors: Osman YILMAZ, Espoo (FI); Carl WIJTING, Espoo (FI); Pekka JÄNIS, Espoo (FI)

(21) Appl. No.: 15/033,728

(22) PCT Filed: Nov. 13, 2013
(86) PCT No.: PCT/IB2013/060116

§ 371 Date: May 2, 2016

(51) Int. Cl. H04B 7/02; H04W 24/02; H04W 72/04

(52) U.S. Cl. CPC H04B 7/024; H04W 72/04; H04W 24/02; H04W 92/20

(57) ABSTRACT

In accordance with an example embodiment of the present invention, an apparatus comprising: at least one processor; and at least one memory including computer program code, wherein the at least one memory and the computer program code are configured to, with the at least one processor, cause the apparatus to perform at least the following: determine backhaul latency between the apparatus and a first node; and cause information associated with backhaul latency or information associated with configuration of cooperation mode to be sent to a cooperating node.

### TECHNICAL FIELD

The present application relates to wireless communications and, in particular, formation of cooperating sets in small cell deployment.

### BACKGROUND

The expected increase in wireless data transmissions may mean that there will be a need to deploy more network capacity. One efficient way to increase the network capacity is by deploying small cells for offloading purposes or offloading cells in general. These small cells can be deployed on the same or separate carriers relative to the serving cell, and the mixed environment with macro/large cells and small cells are often referred to heterogeneous networks (hetnets). Use of hetnets may provide opportunities for offloading traffic from the macro cells to, for example, a higher data rate or a higher capacity small cell.

The heterogeneous network may include one or more wireless access points, or base stations, such as for example an E-UTRAN (evolved Universal Mobile Telecommunications System Terrestrial Radio Access Network) NodeB base station serving macro cells, and one or more small cell base stations serving small cells. For example, a small cell base station (or a wireless access point or a remote radio head, for example) may be implemented to cover a small cell, or coverage area, examples of which include a residence, a small business, a building, an office, or a small area. The small cell base station, such as for example a home base station (HNB), a home E-UTRAN NodeB base station (HeNB), a WiFi access point, and the like, may be configured to have some of the functionality found in a typical base station, such as for example an E-UTRAN NodeB (eNB) base station, but the small cell base station may have less/smaller coverage/range and lower power capabilities given its limited coverage area or class. Furthermore, small cell base station may have limited (or non-ideal) backhaul connection that may have higher latency or lower throughput than macro cell base stations. This limited backhaul connection may affect communication between small cell base station and other base stations and other network elements or nodes. A user equipment may act as an access point or a base station for other devices (multiple devices, or part of device to device communication or group communication), so that in some cases also a user equipment could be considered also a limited capability base station or small cell. For example, the small cell base station may be implemented as a femtocell wireless access point/base station having power sufficient for a cell serving wireless devices within a limited range of about tens of meters. Picocell base stations are another example of a small cell base station, but picocell base stations have somewhat greater range serving a small area on the order of about 100-200 meters. The small cell base station may be implemented as a secondary base station, for example, a secondary cell (SCell) eNB in carrier aggregation. It may also be called a secondary eNB (SeNB). Remote radio head (RRH) may be used to extend the coverage of a macro cell base station, for example, in rural areas or tunnels. The macro cell base station may be also implemented as a primary base station, for example, a primary cell (PCell) eNB in carrier aggregation and may also be called master eNB (MeNB).

With the deployment of small cells, cell densification may result in excessive inter-cell interference (ICI) in case of co-channel deployment. Joint transmission, dynamic point selection/blanking (DPS/DPB) and coordinated scheduling/beamforming (CS/CB) provide promising solutions to mitigate the inter-cell interference in such scenarios. The performance of the scheme largely depends on the number of nodes to be coordinated and their backhaul performance, such as for example latency. Extra delays may result in reduced performance of the scheme.

### SUMMARY

Various aspects of examples of the invention are set out in the claims.

According to a first aspect of the present invention, an apparatus comprising: at least one processor; and at least one memory including computer program code, wherein the at least one memory and the computer program code are configured to, with the at least one processor, cause the apparatus to perform at least the following: determine backhaul latency between the apparatus and a first node; and cause information associated with backhaul latency or information associated with configuration of cooperation mode to be sent to a cooperating node.

According to a second aspect of the present invention, a method comprising: determining backhaul latency between the apparatus and a first node; and causing information associated with backhaul latency or information associated with configuration of cooperation mode to be sent to a cooperating node.

According to a third aspect of the present invention, a computer program product comprising a non-transitory computer-readable medium bearing computer program code embodied therein for use with a computer, the computer program code comprising code for: determining backhaul latency between the apparatus and a first node; and causing information associated with backhaul latency or information associated with configuration of cooperation mode to be sent to a cooperating node.

According to a fourth aspect of the present invention, an apparatus comprising: means for determining backhaul latency between the apparatus and a first node; and means for causing information associated with backhaul latency or information associated with configuration of cooperation mode to be sent to a cooperating node.

According to a fifth aspect of the present invention, an apparatus comprising: at least one processor; and at least one memory including computer program code, wherein the at least one memory and the computer program code are configured to, with the at least one processor, cause the apparatus to perform at least the following: receive information associated with backhaul latency between a first node and a cooperating node or information associated with configuration of cooperation mode; and determine whether to include the first node into a cooperating set or determining a cooperation mode based on the information associated with backhaul latency or the information associated with configuration of cooperation mode.

According to a sixth aspect of the present invention, a method comprising: receiving information associated with backhaul latency between a first node and a cooperating node or information associated with configuration of cooperation mode; and determining whether to include the first node into a cooperating set or determining a cooperation mode based on the information associated with backhaul latency or the information associated with configuration of cooperation mode.

### BRIEF DESCRIPTION OF THE DRAWINGS

For a more complete understanding of example embodiments of the present invention, reference is now made to the following descriptions taken in connection with the accompanying drawings in which:

FIG. 1 depicts an example of a heterogeneous network in which some embodiments of the present invention may be practiced;

FIG. 2 depicts an example process for formation of a cooperating set in accordance with some embodiments of the invention;

FIG. 3 depicts another example process for formation of a cooperating set in accordance with some embodiments of the invention; and

FIG. 4 illustrates a block diagram of a base station in accordance with some embodiments of the invention.

### DETAILED DESCRIPTON OF THE DRAWINGS

Joint processing (JP), coordinated scheduling/beamforming (CS/CB) and dynamic point selection/blanking (DPS/DPB) are coordinated multi-point (CoMP) schemes to mitigate the inter-cell interference. JP scheme typical requires user data synchronization between coordinating points as well as ideal backhaul. In CS/CB and DPS/DPB schemes, user data synchronization between coordinating points as well as ideal backhaul are not required. CS/CB and DPS/DPB schemes may be applied interactively, which means the number of iterations is configured to be more than one in a decentralized implementation. Then, the scheduling decision taken by a cooperating node is informed back to the other cooperating node, which had shared its channel information previously, as many as the number of iterations. However, the large number of iterations would only be possible in case of fast backhaul. In case of non-ideal backhaul, the cooperation delay and/or the cooperation overhead due to the addition of a node or iteration to the cooperating set could deteriorate the performance of the CoMP scheme applied on the UEs.

The subject matter disclosed herein provides a way for the formation of cooperating set based on backhaul performance. Specifically, there is provided a way of signaling exchange between co-operating nodes on the backhaul performance—thus allowing the selection of cooperating set size and/or members and cooperation mode based on the backhaul performance.

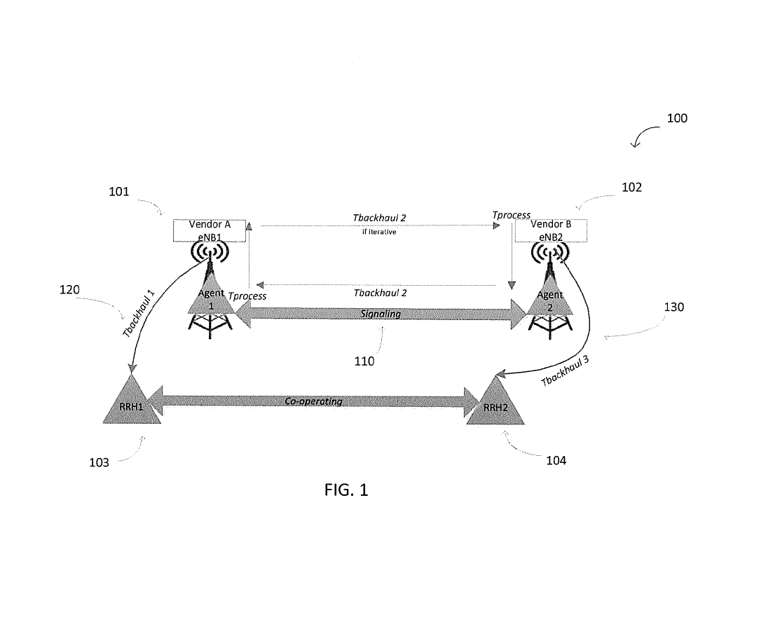

FIG. 1 illustrates an example heterogeneous network 100 in which some example embodiments of the present invention may be practiced. In FIG. 1, eNB1 101 and eNB2 102 are cooperating nodes, for example, they may be a macro cell base station, a master base station or a controlling agent. eNB1 101 is in connection with eNB2 102 via an open interface 110, for example X2, Xn interface, or the like. As illustrated in FIG. 1, cooperation delay between eNB1 and eNB2 comprises backhaul latency, processing time and the delay due to iterative/interactive scheduling, Tcooperation=Tbackhaul+Tprocess+Titeration). Tbackhaul may vary significantly among different links between coordinating eNBs, for example, from below −1 ms to 50 ms. In FIG. 1, RRH1 103 is in connection with eNB1 101 via interface 120 and RRH2 104 is in connection with eNB2 102 via interface 130. The backhaul performance between RRH1 103 and eNB1 101 is not transparent to eNB2 102. Therefore information associated with the backhaul performance between RRH1 103 and eNB1 101 or information associated with configuration of cooperation mode may be sent from eNB1 101 to eNB2 in order to decide whether to include RRH1 into cooperating set as a coordinating point and/or the cooperation mode to operate in.

Although FIG. 1 depicts a certain quantity base stations, other quantities and configurations may be used as well. It is noted that the term of macro base station, master base station and RRH has been and will be hereinafter described for purposes of example, other type of base stations may be used according to the present invention.

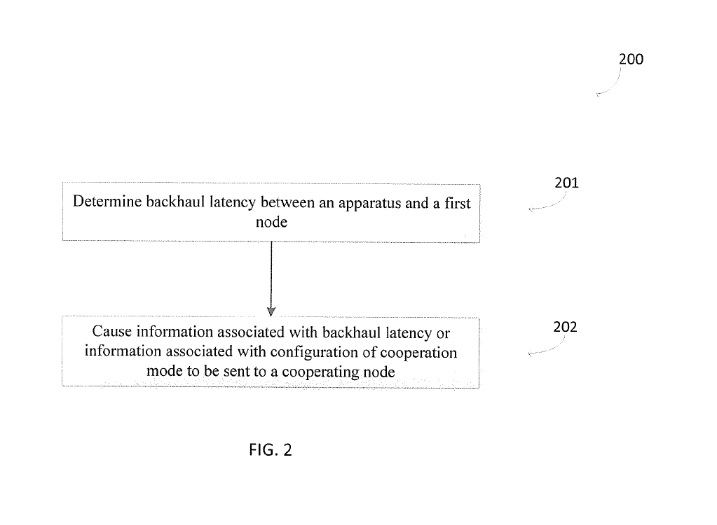

FIG. 2 depicts an example process for formation of a cooperating set in accordance with some embodiments of the invention. Example process 200 may be performed by or in an apparatus, such as eNB 101 in FIG. 1.

At 201, the apparatus determines the backhaul latency between the apparatus and a first node. For example, eNB1 101 may determine the backhaul latency between eNB1 101 and RRH1 103. In some example embodiments, the apparatus may be a macro cell base station, a master base station, or a coordinated multipoint controlling agent. In some example embodiments, the first node may be a small cell base station, a secondary base station, a remote radio head, a relay node, or a base station controlled by a coordinated multipoint controlling agent. The backhaul latency may be determined by measuring or estimating backhaul latency at the apparatus. The backhaul latency may also be determined by receiving backhaul latency report from the first node. For example, eNB1 101 may determine backhaul latency between eNB1 101 and RRH1 103 by measuring or estimating the latency at eNB1 101, or by receiving a backhaul latency report from RRH1 103.

After determining the backhaul latency between the apparatus and a first node, the apparatus may decide whether to include the first node into a cooperating set based on the backhaul latency. For example, the apparatus may decide to include the first node into a cooperating set if the backhaul latency is below a predefined threshold. On the other hand, the apparatus may decide not to include the first node into a cooperating set if the backhaul latency is above a predefined threshold. The apparatus may decide a cooperation mode to operate in based on the backhaul latency. In some example embodiments, the cooperation mode may be joint transmission, dynamic coordinated beamforming, dynamic coordinated scheduling, semi-static coordinated scheduling. Among the example cooperation modes, the required backhaul latency value is increased, that is, joint transmission requires the lowest backhaul latency and semi-static coordinated scheduling mode requires the highest. The cooperation mode may be decided, for example, based on the requirement of backhaul latency for each cooperation mode. If the backhaul latency is too high, for example, above a predefined threshold, the apparatus may decide no cooperation is to be selected. CS/CB and DPS/DPB schemes may be applied interactively, the scheduling decision taken by a cooperating node may be informed back to the other cooperating node, which had shared its channel information previously, as many as the number of iterations allowed by the cooperation mode. The apparatus may decide the number of iterations between the cooperating nodes based on the determined backhaul latency.

At 202, the apparatus transmits information associated with the backhaul latency or information associated with configuration of a cooperation mode to a cooperating node. For example, eNB1 101 may transmit information associated with the backhaul latency or information associated with configuration of a cooperation mode to cooperating node eNB2 102. In some example embodiments, the cooperating node may be a macro cell base station, a master base station or a controlling agent which may decide the cooperating set and the cooperation mode.

In some example embodiments, the apparatus makes decision on the cooperating set and cooperating mode. After determining the cooperation mode, the apparatus may transmit information associated with configuration of the cooperation mode to a cooperating node. The information associated with configuration of cooperation mode may indicate the configuration of cooperation mode or request for configuration of cooperation mode. For example, after determining the cooperation mode to operate in based on the backhaul latency, eNB1 101 may send information to eNB2 102 indicating the determined cooperation mode. After determining whether to include the first node into the cooperating set based on the backhaul latency, eNB1 101 may send information to eNB2 102 indicating whether or not to include the first node into the cooperating set, or eNB1 101 may send information to eNB2 102 only when it has determined to include the first node into the cooperating set.

In some other example embodiments, the cooperating node makes decision on the cooperating set and cooperating mode. In the example embodiments, the apparatus transmits information associated with the backhaul latency to the cooperating node to assist the cooperating node to make the decision. The information associated with backhaul latency may be one or more bits indicating the backhaul latency value. The information associated with backhaul latency may also be one bit indicating whether the backhaul latency is above or below a predefined threshold. After receiving the information associated with the backhaul latency, the cooperating node may decide whether or not to include the first node into the cooperating set and/or the cooperation mode to operate in as described in step 201.

The apparatus may further determine the backhaul capacity of the first node. The backhaul capacity may be estimated by the apparatus. The backhaul capacity may also be determined by receiving backhaul capacity report from the first node. For example, eNB1 101 may determine the backhaul capacity of RRH1 103 by estimating the capacity at eNB1 101, or by receiving a backhaul capacity report from RRH1 103.

The apparatus may further use the backhaul capacity together with the backhaul latency to decide whether to include the first node into a cooperating set. For example, the apparatus may decide to include the first node into a cooperating set if the backhaul latency is below a predefined threshold and there is available capacity in the backhaul of the first node. The apparatus may use the backhaul capacity together with the backhaul latency to decide a cooperation mode to operate in. For example, the apparatus may decide the cooperation mode based on the backhaul latency, the requirement of backhaul latency for each cooperation mode and whether there is available capacity in the backhaul of the first node. If the backhaul latency is too high, for example, above a predefined threshold, or if the available capacity is below a predefined threshold, the apparatus may decide no cooperation is to be selected.

If decision on cooperating set and cooperating mode is made in the cooperating node, the apparatus may further send information associated with the backhaul capacity to the cooperating node to assist the cooperating node to make decision. The information associated with backhaul capacity may be one or more bits indicating the backhaul capacity value. The information associated with backhaul capacity may also be one bit indicating whether or not there is available capacity in the backhaul of the first node.

After determining the cooperation mode, the apparatus may send information associated with configuration of cooperation mode to the first node. For example, eNB1 101 may send information associated with configuration of cooperation mode to RRH1 103.

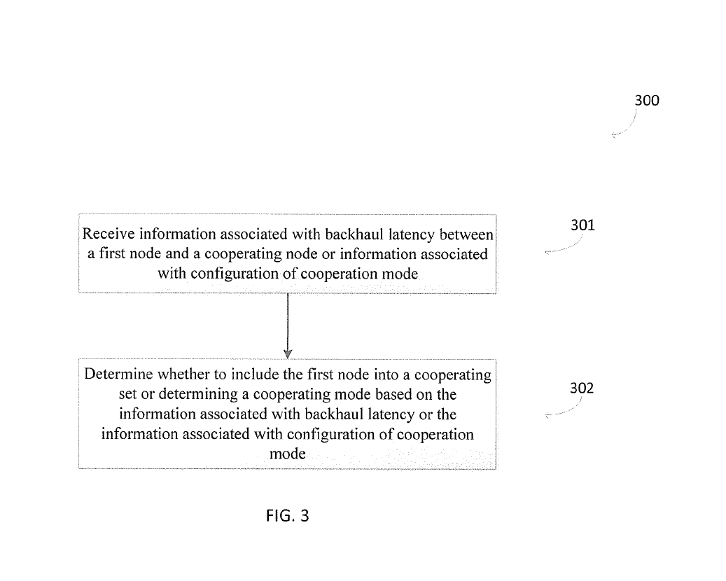

FIG. 3 depicts another example process for formation of a cooperating set in accordance with some embodiments of the invention. Example process 300 may be performed by or in an apparatus, such as eNB2 102 of FIG. 1.

At 301, the apparatus receives information associated with backhaul latency between a first node and a cooperating node or information associated with configuration of cooperation mode. For example, eNB2 102 may receive information associated with backhaul latency between eNB1 101 and RRH1 103 or receive information associated with configuration of cooperation mode from eNB1 101. In some example embodiments, the apparatus may be a macro cell base station, a master base station, or a coordinated multipoint controlling agent. In some example embodiments, the first node may be a small cell base station, a secondary base station, a remote radio head, a relay node, or a base station controlled by a coordinated multipoint controlling agent, for example, RRH1 103. In some example embodiments, the cooperating node may be a macro cell base station, a master base station or a controlling agent, for example, eNB1 101.

At 302, the apparatus determines whether to include the first node into a cooperating set or determines a cooperation mode based on the information associated with backhaul latency or the information associated with configuration of cooperation mode. In some example embodiments, the apparatus makes decision on whether to include the first node into a cooperating set and/or the cooperation mode to operate in. The apparatus makes decision based on the received information associated with backhaul latency. The apparatus may decide whether to include the first node into a cooperating set based on the backhaul latency. For example, the apparatus may decide to include the first node into a cooperating set if the backhaul latency is below a predefined threshold. On the other hand, the apparatus may decide not to include the first node into a cooperating set if the backhaul latency is above a predefined threshold. In some other example embodiments, the cooperating node makes the decision and the apparatus receives the configuration of cooperation mode from the cooperating node.

The information associated with backhaul latency may be one or more bits indicating the backhaul latency value. The information associated with backhaul latency may also be one bit indicating whether the backhaul latency is above or below a predefined threshold. The information associated with configuration of cooperation mode may indicate the configuration of cooperation mode or request for configuration of cooperation mode.

The apparatus may further receive information associated with the backhaul capacity of the first node from the cooperating node. The apparatus may further use the backhaul capacity together with the backhaul latency to decide whether to include the first node into a cooperating set. For example, the apparatus may decide to include the first node into a cooperating set if the backhaul latency is below a predefined threshold and there is available capacity in the backhaul of the first node. The apparatus may use the backhaul capacity together with the backhaul latency to decide a cooperation mode to operate in. For example, the apparatus may decide the cooperation mode based on the backhaul latency, the requirement of backhaul latency for each cooperation mode and whether there is available capacity in the backhaul of the first node. If the backhaul latency is too high, for example, above a predefined threshold, or if the available capacity is below a predefined threshold, the apparatus may decide no cooperation is to be selected.

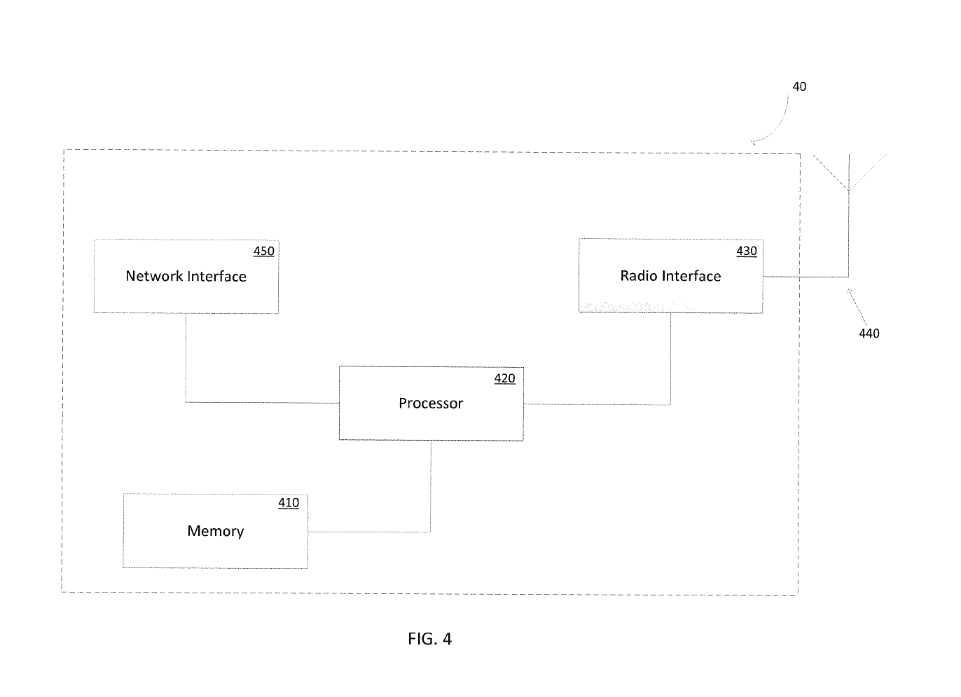

FIG. 4 depicts an example implementation of a base station in accordance with some embodiments of the invention, such as eNB1 101, eNB2 102, RRH1 103 and RRH2 104 in FIG. 1. The base station 40 may include one or more antennas 440 configured to transmit via a downlink and configured to receive uplinks via the antenna(s). The base station may further include a plurality of radio interfaces 430 coupled to the antenna 440. The radio interfaces may correspond one or more of the following: Long Term Evolution (LTE, or E-UTRAN), Third Generation (3G, UTRAN, or high speed packet access (HSPA)), Global System for Mobile communications (GSM), wireless local area network (WLAN) technology, such as for example 802.11 WiFi and/or the like, Bluetooth, Bluetooth low energy (BT-LE), near field communications (NFC), and any other radio technologies. The radio interface 430 may further include other components, such as filters, converters (for example, digital-to-analog converters and the like), mappers, a Fast Fourier Transform (FFT) module, and the like, to generate symbols for a transmission via one or more downlinks and to receive symbols (for example, via an uplink). The base station may further include one or more network interfaces 450, such as interface 110 in FIG. 1, for receiving and transmitting to other base stations. The base station may further include one or more processors, such as processor 420, for controlling the interfaces 430 and 450 and for accessing and executing program code stored in memory 410. In some example embodiments, the memory 410 includes code, which when executed by at least one processor causes one or more of the operations described herein with respect to a base station.

Without in any way limiting the scope, interpretation, or application of the claims appearing below, a technical effect of one or more of the example embodiments disclosed herein may include formation of cooperating set for coordinated multipoint operation.

Embodiments of the present invention may be implemented in software, hardware, application logic or a combination of software, hardware and application logic. The software, application logic and/or hardware may reside on a non-transitory memory 410, the control apparatus 40 or electronic components, for example. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 4. A computer-readable medium may comprise a computer-readable non-transitory storage medium that may be any media or means that can contain or store the instructions for use by or in connection with an instruction execution system, apparatus, or device, such as a computer. The scope of the present invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims. Other embodiments may be within the scope of the following claims. The term “based on” includes “based at least in part on”.

1-28. (canceled)

29. A method, comprising:
determining, by an apparatus, backhaul latency between the apparatus and a first node; and
causing information associated with backhaul latency or information associated with configuration of cooperation mode to be sent to a cooperating node.

30. The method of claim 29, wherein the apparatus comprises at least one of: a macro cell base station, a master base station and a coordinated multipoint controlling agent.

31. The method of claim 29, wherein the first node comprises at least one of: the cooperating node, a small cell base station, a secondary base station, a remote radio head a relay node, and a base station controlled by a coordinated multipoint controlling agent.

32. The method of claim 29, wherein the information associated with backhaul latency comprises one bit indicating whether the backhaul latency is above or below a predefined threshold.

33. The method of claim 29, further comprising at least one of:
determining whether to include the first node into a cooperating set based on the backhaul latency, and
determining a cooperation mode based on the backhaul latency.

34. The method of claim 33, wherein determining whether to include the first node into a cooperating set based on backhaul latency comprises including the first node into a cooperating set if the backhaul latency is below a predefined threshold.

35. The method of claim 33, wherein the cooperation mode is determined from one of the following modes: joint transmission, dynamic coordinated beamforming, dynamic coordinated scheduling, semi-static coordinated scheduling.

36. The method of claim 29, further comprising:
determining backhaul capacity of the first node; and
determining whether to include the first node into a cooperating set or determining cooperation mode based on the backhaul latency and the backhaul capacity.

37. An apparatus, comprising:
at least one processor; and
at least one memory including computer program code,
wherein the at least one memory and the computer program code are configured to, with the at least one processor, cause the apparatus to perform at least the following:
determine backhaul latency between the apparatus and a first node; and
cause information associated with backhaul latency or information associated with configuration of cooperation mode to be sent to a cooperating node.

38. The apparatus of claim 37, wherein the apparatus comprises at least one of: a macro cell base station, a master base station and a coordinated multipoint controlling agent.

39. The apparatus of claim 37, wherein the first node comprises at least one of: the cooperating node, a small cell base station, a secondary base station, a remote radio head a relay node, and a base station controlled by a coordinated multipoint controlling agent.

40. The apparatus of claim 37, wherein determining backhaul latency comprises at least one of: estimating backhaul latency and receiving backhaul latency report from the first node.

41. The apparatus of claim 37, wherein the information associated with backhaul latency comprises one bit indicating whether the backhaul latency is above or below a predefined threshold.

42. The apparatus of claim 37, wherein the apparatus is caused to further perform at least one of:
determine whether to include the first node into a cooperating set based on the backhaul latency, and
determine a cooperation mode based on the backhaul latency.

43. The apparatus of claim 42, wherein determining whether to include the first node into a cooperating set based on backhaul latency comprises including the first node into a cooperating set if the backhaul latency is below a predefined threshold.

44. The apparatus of claim 42, wherein the cooperation mode is determined from one of the following modes: joint transmission, dynamic coordinated beamforming, dynamic coordinated scheduling, semi-static coordinated scheduling.

45. The apparatus of claim 42, wherein determining the cooperation mode comprises determining a number of iterations between the cooperating nodes.

46. The apparatus of claim 42, wherein the apparatus is caused to further perform:
cause information associated with configuration of cooperation mode to be sent to the first node.

47. The apparatus of claim 37, wherein the apparatus is caused to further perform:
determine backhaul capacity of the first node; and
determine whether to include the first node into a cooperating set or determining cooperation mode based on the backhaul latency and the backhaul capacity.

48. A method, comprising:
receiving, by an apparatus, information associated with backhaul latency between a first node and a cooperating node or information associated with configuration of cooperation mode; and
determining whether to include the first node into a cooperating set or determining a cooperation mode based on the information associated with backhaul latency or the information associated with configuration of cooperation mode.
